(19) United States
(12) Patent Application Publication
(10) Pub. No.: US 2022/0391943 A1
(43) Pub. Date: Dec. 8, 2022

(54) ADVOCATE ENGAGEMENT SYSTEMS AND METHODS

(71) Applicant: EyCrowd, Inc, Castle Rock, CO (US)

(72) Inventors: Bradley COWDREY, Castle Rock, CO (US); Ayman AL-ZAMIL, Riyadh (SA)

(21) Appl. No.: 17/832,222

(22) Filed: Jun. 3, 2022

Related U.S. Application Data
(63) Continuation of application No. PCT/US2022/032015, filed on Jun. 2, 2022.
(60) Provisional application No. 63/299,755, filed on Jan. 14, 2022.
(60) Provisional application No. 63/196,571, filed on Jun. 3, 2021.

(51) Int. Cl. G06Q 30/02

(52) U.S. Cl. CPC G06Q 30/0242

(57) ABSTRACT

A system for engaging advocates for one or more campaigns. The system includes a database for storing the campaigns. Each campaign is associated with one or more tasks for completion and a requesting user. The system further includes an advocate user device communicatively coupled to the database. The advocate user device has an interactive device-based platform configured to enable an advocate user, via the advocate user device, to: join a campaign from among the one or more campaigns stored on the database, complete tasks associated with the joined campaign, and verify the completion of tasks associated with the selected campaign to the requesting user.

### CROSS-REFERENCE TO RELATED APPLICATIONS

This application is a continuation of PCT/US2022/32015, filed Jun. 2, 2022, which claims the benefit of U.S. Provisional Application No. 63/196,571, filed Jun. 3, 2021, and U.S. Provisional Application No. 63/299,755, filed Jan. 14, 2022, the disclosures of which are expressly incorporated by reference herein.

### FIELD OF THE INVENTION

The present invention relates to advocate engagement systems that operate to provide a campaign service to one or more requesting users by way of a software application executed on a plurality of advocate user devices, which configures the devices to present the advocate users with one or more campaigns that can be selected by the advocate user for completion, and whose completion can be facilitated and verified via the configured device.

### BACKGROUND OF THE INVENTION

It is an object of the disclosure to provide advocate engagement systems that operate to provide a campaign service to one or more requesting users by way of a software application executed on a plurality of advocate user devices, which configures the devices to present the advocate users with one or more campaigns that can be selected by the advocate user for completion, and whose completion can be facilitated and verified via the configured device.

Other objects, advantages and novel features of the present invention will become apparent from the following detailed description of one or more preferred embodiments when considered in conjunction with the accompanying drawings. It should be recognized that the one or more examples in the disclosure are non-limiting examples and that the present invention is intended to encompass variations and equivalents of these examples. The disclosure is written for those skilled in the art. Although the disclosure use terminology and acronyms that may not be familiar to the layperson, those skilled in the art will be familiar with the terminology and acronyms used herein.

### BRIEF DESCRIPTION OF THE DRAWINGS

The features, objects, and advantages of the present invention will become more apparent from the detailed description, set forth below, when taken in conjunction with the drawings, in which like reference characters identify correspondingly throughout and wherein:

FIG. 1 is a schematic view of an exemplary system according to at least one aspect of the invention;

FIG. 2 is a schematic view of an exemplary architecture according to at least one aspect of the invention; and

FIGS. 3-30 are exemplary schematic screenshots illustrating exemplary functions and processes according to at least one aspect of the invention.

### DETAILED DESCRIPTION OF THE DRAWINGS

The above described drawing figures illustrate aspects of the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one embodiment of the invention with the understanding that the present disclosure is to be considered as an exemplification of the principles of the present invention, and is not intended to limit the broad aspects of the present invention to any embodiment illustrated. It will therefore be understood that what is illustrated is set forth for the purposes of example, and should not be taken as a limitation on the scope of the present invention.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment.

Furthermore, the particular features, structures, or characteristics may be combined in any suitable manner on one or more embodiments without limitation. The term “or” as used herein is to be interpreted as inclusive or meaning any one or any combination.

In accordance with the practices of persons skilled in the art, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description and corresponding figures, numerous specific details are set forth in order to provide a thorough understanding of the present invention. However, it should be appreciated that the invention may be practiced without such specific details. Additionally, for brevity sake well-known methods, procedures, components, and circuits have not been described in detail.

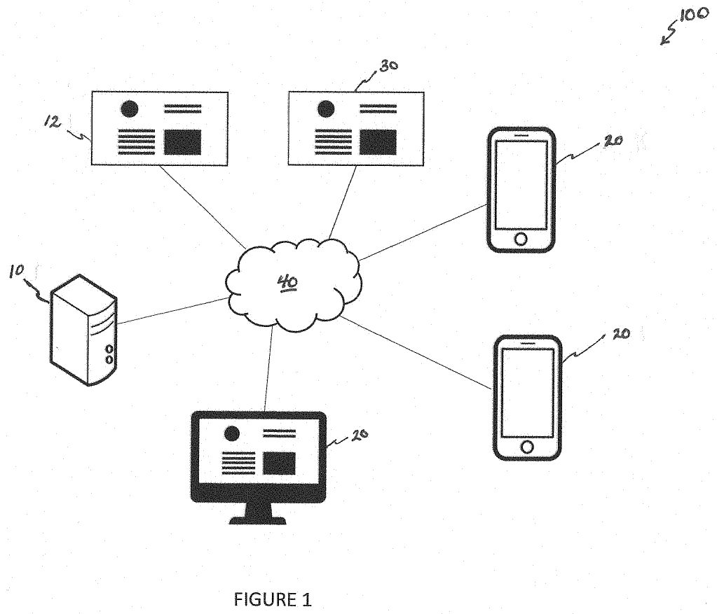

FIG. 1 illustrates an advocate engagement system in accordance with one or more aspects of the disclosure. In general, the advocate engagement system operates to provide a campaign service to one or more requesting users by way of a software application executed on a plurality of advocate user devices 20. When executed on an advocate user device, the software application configures the device to present the advocate user with one or more campaigns, requested by requesting users, which can be selected by the advocate user for completion via the performance of one or more tasks associated with the selected campaign, and to facilitate and verify the completion of the one or more tasks and/or the campaign to the requesting users. The requesting user may, for example, be associated with a company or organization that desires to conduct a campaign via the advocate engagement system.

The advocate engagement system may include a system server 10 configured to support a website 12 and the software application, with respect to one or more of the functions and/or processes thereof, as described herein. The system server may include one or more computing devices, including one or more server computers and storage devices, and may be connected to a network 40 via which the system server and/or any of its components may communicate with other computing devices connected to the network. The server computers may include components typically associated with a computer, such as one or more processors, physical memories, software instructions, data, displays, and interfaces.

The processor of the server computer may instruct the components thereof to perform various tasks based on the processing of information and/or data that may have been previously stored or have been received, such as instructions and/or data stored in the memory and/or the storage devices. The processors may be standard processors, such as a central processing unit (CPU), or may be dedicated processors, such as an application-specific integrated circuit (ASIC) or a field programmable gate array (FPGA).

The memory stores at least instructions and/or data that can be accessed by the processor. For example, the memory may be hardware capable of storing information accessible by the processor, such as a ROM, RAM, hard-drive, CD-ROM, DVD, write-capable, read-only, etc. The set of instructions may be included in software that can be implemented on the server computer. It should be noted that the terms “instructions,” “steps,” “algorithm,” and “programs” may be used interchangeably. Data can be retrieved, manipulated or stored by the processor in accordance with the set of instructions or other sets of executable instructions. The data may be stored as a collection of data.

The server computer accordingly may include one or more software applications, stored in the memory, which software applications, when executed by the processor configures the server computer to function as described herein. In particular, the server computer may be configured to host and/or otherwise support the online platform (i.e., the website), and to send and/or receive data to and from the server computer. The software may further configure the server computer to allow the requesting user to interact with the website as described herein.

The display may be any type of device capable of communicating data to users, such as a liquid-crystal display (“LCD”) screen, a plasma screen, etc. The interface allows users to communicate with the server computer and may be a physical device (e.g., a port, a keyboard, a mouse, a touch-sensitive screen, microphone, camera, a universal serial bus (USB), CD/DVD drive, zip drive, card reader, etc.) and/or may be virtual (e.g., a graphical user interface “GUI,” etc.).

The server system may also include one or more storage devices configured to store large quantities of data and/or information, and may further include one or more databases. For example, the storage device may be a collection of storage components, or a mixed collection of storage components, such as ROM, RAM, hard-drives, solid-state drives, removable drives, network storage, virtual memory, cache, registers, etc. The storage device may also be configured so that the server computers may access it in furtherance of executing the functions of the system server described herein. In some embodiments, the storage of the data may be in accordance with one or more database management systems implemented by the server system.

The server computers may be rack mounted on a network equipment rack and/or located, for instance, in a data center. The server computers may use the network to serve the requests of programs executed on the advocate user devices, the requesting user devices and/or the storage device.

The network may be any type of network (e.g., wired and/or wireless) configured to facilitate the communication and transmission of data, instructions, etc. from one component to another component of the network. For example, the network may be a local area network (LAN) (e.g., Ethernet or other IEEE 802.03 LAN technologies), Wi-Fi (e.g., IEEE 802.11 standards, wide area network (WAN), virtual private network (VPN), global area network (GAN)), any combination thereof, or any other type of network.

The advocate engagement system further includes a plurality of advocate user devices communicatively connected to the network. The advocate user devices are generally computing devices of requesting users, and may include mobile (e.g., laptop computer, tablet computer, smartphone, PDA, wearable, etc.) or stationary (e.g., desktop computer, etc.), multi-purpose or dedicated, devices configured to communicate data and information with the other network components. In some embodiments, the advocate user devices may be augmented and/or virtual reality devices, or brain-machine interface devices for connecting humans and computers (e.g., neuro-links, etc.). The advocate user devices may include components typically associated with such devices, such as one or more processors, physical memories, software instructions, data, displays, and interfaces.

The processors may instruct the computer components to perform various tasks based on the processing of information and/or data that may have been previously stored or have been received, such as software instructions and/or data stored in the memory. The processors may be standard processors, such as a central processing unit (CPU), or may be dedicated processors, such as an application-specific integrated circuit (ASIC) or a field programmable gate array (FPGA).

The memory stores at least instructions and/or data that can be accessed by the processor. For example, the memory may be hardware capable of storing information accessible by the processor, such as a ROM, RAM, hard-drive, CD-ROM, DVD, write-capable, read-only, etc. The set of instructions may be included in software that can be implemented on the advocate device. It should be noted that the terms “instructions,” “steps,” “algorithm,” and “programs” may be used interchangeably. Data can be retrieved, manipulated or stored by the processor in accordance with the set of instructions or other sets of executable instructions. The data may be stored as a collection of data.

The advocate user devices accordingly may include one or more software applications, stored in the memory, which software applications, when executed by the processor configures the advocate user device to function as described herein. In particular, the advocate user device may be configured to present the advocate user with one or more campaigns, which can be selected by the advocate user for completion via the performance of one or more tasks associated with the selected campaign, and to facilitate and verify the completion of the one or more tasks and/or the selected campaigns.

The display may be any type of device capable of communicating data to users, such as a liquid-crystal display (“LCD”) screen, a plasma screen, touch-sensitive screen, etc. The interface allows users to communicate with the advocate user device and may be a physical device (e.g., a port, a keyboard, a mouse, a touch-sensitive screen, microphone, camera, a universal serial bus (USB), CD/DVD drive, zip drive, card reader, etc.) and/or may be virtual (e.g., a graphical user interface “GUI,” etc.).

The advocate engagement system may further include one or more requesting user devices 20 communicatively connected to the network. The requesting user devices are generally computing devices of requesting users, and may include mobile (e.g., laptop computer, tablet computer, smartphone, PDA, wearable, etc.) or stationary (e.g., desktop computer, etc.) devices configured to communicate data and information with the other network components. Similar to the advocate user devices and the server computers, the requesting user devices may include components typically associated with such devices, such as one or more processors, physical memories, software instructions, data, displays, and interfaces, whose overlapping details are apparent from the corresponding discussion with respect to the similar devices and will not be discussed further.

The requesting user devices accordingly may include one or more software applications, stored in the memory, which software applications, when executed by the processor configures the requesting user devices to function as described herein. In particular, the requesting user devices may be configured to access the online platform (i.e., the web site), and to send and/or receive data to and from the server computer. The software may further configure the requesting user devices to allow the requesting user to interact with the website supported by the system server.

In particular, the website may provide a platform via which the requesting user may define, request, modify, delete and/or otherwise manage one or more campaigns. Each campaign may be defined by one or more campaign parameters, including but not limited to: the campaign name, the associated organization(s), the time, duration and location of the campaign, the type of campaign (e.g., in-person, digital, hybrid, etc.), the compensation to be paid to the advocate user upon successful completion of the campaign, the demographic preferences/requirements (e.g., interests, linked social media accounts, disabilities, etc.) for the campaign, the number of advocate users desired for the campaign, the campaign tasks (e.g., pre-campaign tasks, live-campaign tasks, follow-up campaign tasks), and any other parameter defining the campaign.

In some embodiments, the time and duration of the campaign can comprise one or more periods with respect to which other parameters may be defined, or vice versa. For example, a joining period may be when the campaign is available for advocate users to join. A pre-campaign period may be when the advocate users can check into the campaign and pre-campaign tasks, if any, are available for completion by the advocate users. A live-campaign period may be when live-campaign tasks are available for completion by the advocate users. And a follow-up period may be when follow-up tasks are available to the advocate user for completion. In some embodiments, each of the defined periods are distinct periods, whereas in some embodiments, the defined periods may overlap. For example, an on-demand or ad hoc campaign may have coinciding pre, live and post campaign periods—and may be available to advocate users for completion on-demand rather than according to a scheduled start. As another example, the advocate user may register for a campaign for which the pre, live and post campaign periods may start at a later time according to a schedule set by the time parameters. Moreover, the one or more periods are preferably defined with respect to each campaign, such that they constitute campaign parameters for the specific campaign.

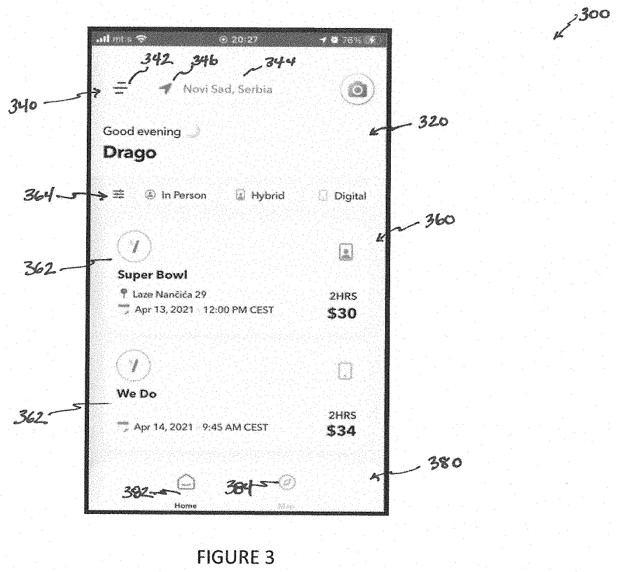

In some embodiments, the campaign type refers to a classification of the campaign, which may be any desired classification. For example, the campaign type parameter may classify campaigns into in-person campaigns, digital campaigns and hybrid campaigns, based on whether the campaign requires in-person attendance, can be done entirely digitally without in-person attendance, or both, as the case may be. FIGS. 3-14 illustrate aspects of an exemplary campaign selection and completion process for an in-person campaign, and for a digital campaign.

The defined campaign, including campaign data reflecting the defined parameters, may be saved to the database, and may be accessible by the advocate user device, the requesting user device and/or the server computer.

The system server may further be configured to implement a matching algorithm so as to match candidate campaigns to advocate users based on the campaign data and the user profile data. The matching algorithm, for example, may match advocate users and candidate campaigns based on overlapping parameters, such as, for example, location, interests and demographics. In some embodiments, the matching algorithms may prioritize candidate campaigns according to how closely the advocate user matches each candidate campaign. In at least one embodiment, the matching algorithm matches advocate users and candidate campaigns according to the interests of the advocate user and the values of the requesting user and/or associated organization.

Accordingly, the system server may also receive and manage user profile data from the advocate user devices, and retrievably save such user profile data to the database. The user profile data may include data regarding user interests, campaigns joined, completed and/or withdrawn from, and other user data discussed or implied herein. The system server can use the user profile data to identify candidate campaigns for each advocate user based on the results of the matching algorithm. The campaign data for the candidate campaigns may be then transmitted to the advocate user device, and used therein as discussed.

The advocate engagement system may further include one or more social media platforms 30 connected to and accessible via the network. The social media platforms may be accessible by the advocate user devices to upload data, including posting and/or sharing content, to the social media platform, as discussed herein. It will be understood that the advocate engagement system may include one or more APIs for accessing the social media platforms, such that the social media platforms need not be controlled by the same entity as the advocate engagement system. Indeed, in at least some embodiments, the advocate user device 20 may include software for accessing the social media platforms so as to carry out one or more of the associated functions described herein (e.g., posting, tagging, etc.).

It is to be understood that the configuration illustrated in FIG. 1 serves only as an example and the advocate engagement system is not limited thereto. The advocate engagement system, for instance, may include less than all the described components, or additional components connected to the network, including more than one of any of the components, and the network may be connected to other networks.

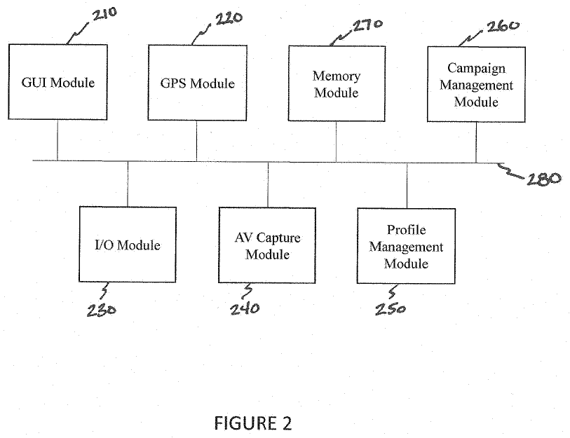

FIG. 2 illustrates an exemplary advocate device architecture 200 in accordance with at least one embodiment. The architecture includes a graphical user interface (“GUI”) module 210, a geo-positioning (“GPS”) module 220, an input/output (“I/O”) module 230, an audio-visual (“AV”) capture module 240, a profile management module 250, a campaign management module 260, and a memory module 270, each communicatively coupled via an internal network 280 (e.g., a data bus).

The GUI module is configured to control one or more components of the advocate user device to enable the advocate user to interact with the advocate user device and vice versa, via a graphical user interface (“GUI”), in furtherance of the functions described herein. Such components may include, for example, one or more cameras, microphones, speakers, position sensors (e.g., accelerometers, angular velocity sensors, etc.), haptic feedback devices, user input devices (e.g., touch-sensitive surfaces, keyboard, mouse, etc.), and/or any other device capable of enabling such interaction.

The I/O module is configured to control components of the advocate user device that enable the advocate user device to send/receive data to/from the network in furtherance of the functions described herein. Such components may include, for example, a wired or wireless transceiver that communicatively couples the user advocate device to the network. In particular, the I/O module is configured to exchange user profile data and campaign data with the system server. The I/O module is also configured to enable the advocate user to post, comment and otherwise engage in social media activity, via communication with the social media platform, through the advocate user device executing the software application. In at least one embodiment, the I/O module may access captured media (e.g., photos, video, etc.) stored in the memory so as to post the captured media on the social media platform. The I/O module may, for example, access the memory so as to transfer the captured media to one or more social media software applications on the advocate user device, such that the advocate user, via the social media software application, can post the captured media. Such transfer may be direct or via some intermediary (e.g., the advocate user device operating system or some other module).

The GPS module is configured to control components of the advocate user device that enable the advocate user device to determine its geographic location in furtherance of the functions described herein. Such components may include, for example, a GPS transceiver unit and/or any other device capable of enabling such geographic location determination.

The AV capture module is configured to control components of the advocate user device to enable the advocate user device to capture audio and/or visual content in furtherance of the functions described herein. Such components may include, for example, one or more cameras, microphones and/or any other devices capable of enabling such audio and/or visual content capture. In particular, the AV module is also configured to enable the advocate user to capture audio and/or visual content for posting on social media platforms through the advocate user device executing the software application.

The memory module is configured to control components of the advocate user device to enable the advocate user device to store, access, delete, modify and otherwise manage data storage on one or more physical memories of the advocate user device in furtherance of the functions described herein. Such data may include campaign data and/or user profile data, as discussed herein. The data may be stored in one or more databases with respect to which the memory module may comprise a database management system. In at least one embodiment, the memory module includes a media gallery, where captured media (e.g., via the AV capture module) may be accessibly stored for later use (e.g., posting on social media) by other modules and/or devices.

The profile management module is configured to control or otherwise cooperate with components of the advocate user device to generate, store, update and otherwise maintain a user profile associated with the advocate user in furtherance of the functions of the advocate engagement system. The user profile may include user profile data, including, for example, advocate user name, home location, friend/contact information, social media account information, calendar information, schedule information, interests, demographic information, information regarding completed and pending campaigns, payment account information, and any other information that may be utilized in furtherance of the functions of the advocate engagement system. The user profile data may further include data regarding the actions or activities of the advocate user, such as, for example, data regarding social media activity, the completion and/or non-completion of campaign tasks, the completion and/or non-completion of campaigns, etc.

The user profile and/or the user profile data may be stored in the one or more databases, and may be communicated to other components of the advocate engagement system, including the system server and other components of the advocate user device, or other advocate user devices.

In operation, the profile management module enables the advocate user device to generate, update and otherwise maintain the user profile of the advocate user. In particular, the advocate user may, via the GUI, provide the user profile data to the advocate device or otherwise update or delete such user profile data. The profile management module also enables the advocate user device to update the user profile based on campaign data, or other data, received from the system server, or other source.

The profile management module is further generally configured to manage the presentation and functions of the one or more screens according to the campaign selection and completion process discussed herein, based on the profile data.

The campaign management module is configured control or otherwise cooperate with components of the advocate user device to retrieve, transmit, generate, store, update and otherwise maintain and/or manage campaign data in in furtherance of the functions of the advocate engagement system. The campaign data may include data regarding campaign parameters, the completion and/or non-completion of campaign tasks, the completion and/or non-completion of campaigns, and any other campaign related information that may be utilized in furtherance of the functions of the advocate engagement system

The campaign management module is further generally configured to manage the presentation and functions of the one or more screens according to the campaign selection and completion process discussed herein, based on the campaign data.

FIGS. 3 to 14 and 22 to 30 illustrate, by way of depicted screenshots of exemplary graphical user interfaces provided by the advocate user device, exemplary functions and processes via which the advocate user device is used to provide the campaign services, in accordance with at least one embodiment. The figures therefore also illustrate an exemplary campaign selection and completion process according to at least one embodiment. It will be understood, however, that the advocate engagement system preferably includes a plurality of similarly functioning advocate user devices.

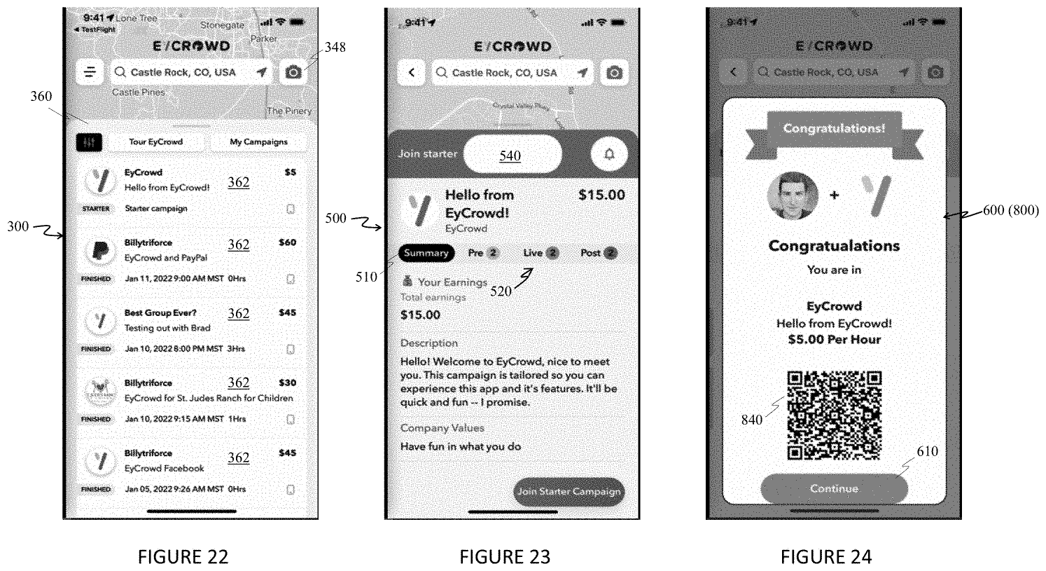

As shown in the figures, the advocate user device is configured to provide an interactive device-based platform via which the advocate user can search, join and complete campaigns, as well as manage their user profile and interactions with other advocate users. Accordingly, a home screen 300 may be provided by the advocate user device as a starting point from which to navigate the system functions. An exemplary home screen is shown in FIG. 3, and can include the advocate user information tab 320, an app navigation tab 340, a campaign tab 360, and a mode toggle tab 380. Another exemplary home screen is shown in FIG. 22.

The advocate user information tab displays information related to the advocate user. For example, the advocate user information tab may display the advocate user name and a customized greeting or other message determined based on an analysis of the user profile data.

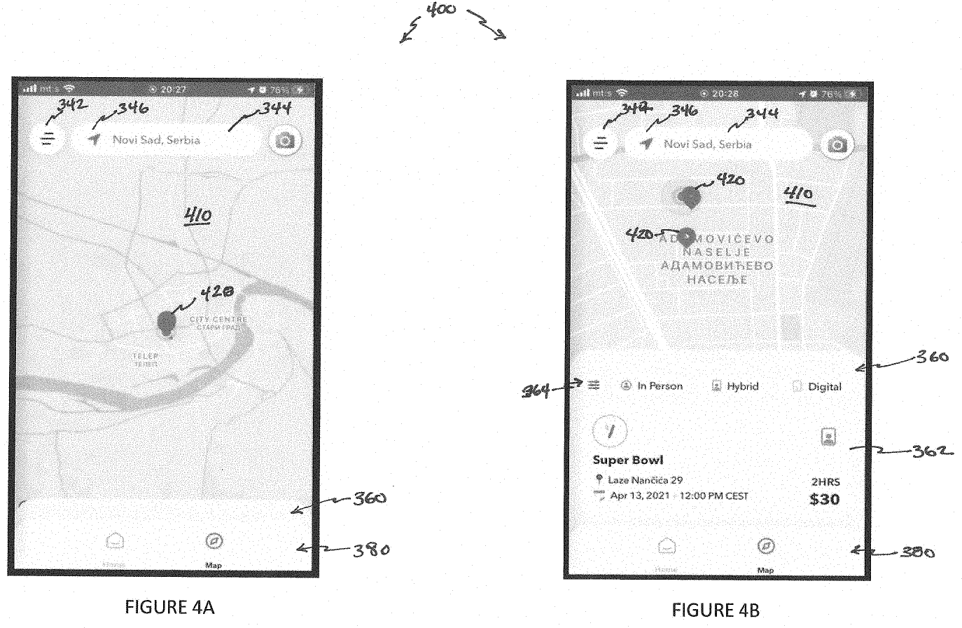

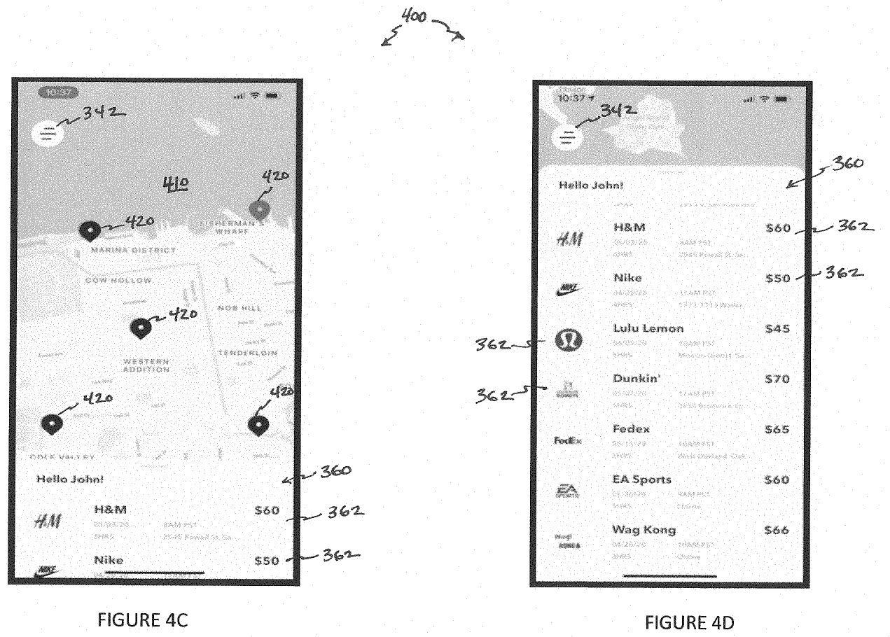

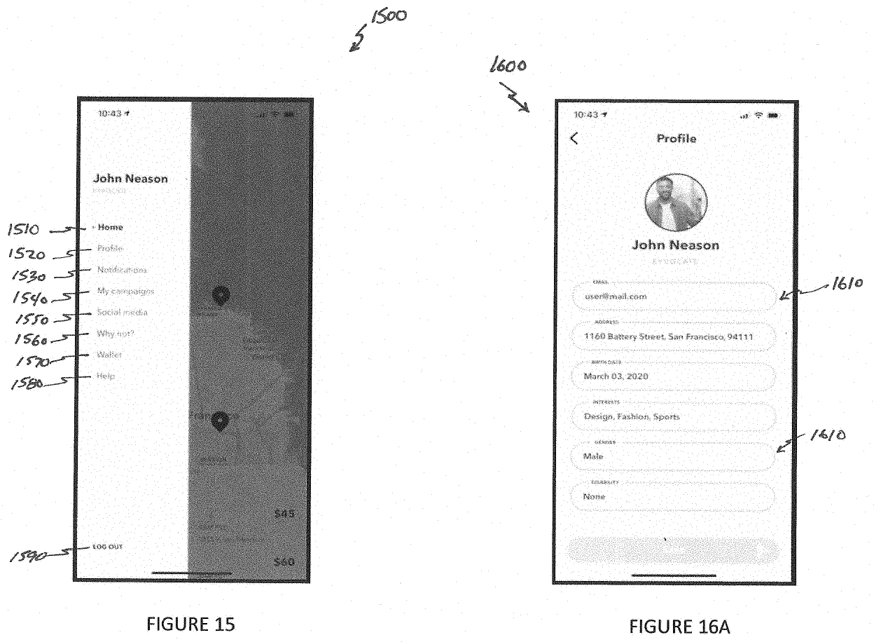

The app navigation tab includes a menu button 342 whose actuation transitions the GUI to a menu screen 1500, which is discussed further with reference to FIGS. 15 to 21. The app navigation tab also includes a location search field 344 via which the advocate user may input a location and thereby initiate a search for campaigns nearby the input location. In some embodiments, inputting a location into the location search field may cause the GUI to transition to a map screen 400, which is discussed with reference to FIGS. 4A-4D. The app navigation tab may also include a current location button 346, the selection of which may cause the current GPS location of the advocate device to be input to the location search field. The home screen may also include (e.g., as part of the app navigation tab) a camera access button 348 via which the advocate user can activate the device camera, in accordance with the functions described herein.

The campaign tab includes one or more campaign cells 362, which may be arranged in a scrollable array or other arrangement such that the advocate user may easily review the presented campaign cells. In some embodiments, the campaign tab may be extendable by a dragging motion via the GUI, so as to display more or less campaign cells.

Each campaign cell corresponds to a campaign defined by a respective requesting user via the online platform, as discussed herein. The campaign tab may include campaigns joined by the advocate user and/or candidate campaigns that have not been joined by the user, but preferably includes only joined campaigns. The selection of the campaign cell by the advocate user may transition the GUI to an associated campaign screen based on the current stage in the campaign selection and completion process for the corresponding campaign, as will be apparent from the descriptions herein. In some embodiments, the campaign tab may be further configured to display only those campaigns that are nearby the input location of the input search field, such that inputting the location into the location search field may initiate a location-based filtering and/or prioritization of the campaign cells in the campaign tab.

In addition, each campaign cell displays campaign data associated with the corresponding campaign. The campaign data displayed by the campaign cell is preferably a portion of the campaign data, and may include, for example, the campaign title, location, date, time, duration, type and compensation.

In some embodiments, the campaign tab includes a filter tab 364, via which the advocate user can filter the campaign cells included in the campaign tab. For example, the campaign tab can be filtered according to campaign type, so as to only show in-person campaigns, digital campaigns, or hybrid campaigns.

The mode toggle tab includes a home button 382, whose selection transitions the GUI to the home screen, if it is not already at the home screen, and a map button 384, whose selection transitions the GUI to the map screen.

The advocate engagement system is further generally configured to enable the advocate user to use the advocate user device to search for campaigns. Turning now to FIGS. 4A-4D, the advocate user device is configured to provide the interactive map screen. The map screen includes the location search field, the mode toggle tab, the campaign tab.

As discussed, the location search filed enables the advocate user to search for campaigns nearby the input location, and the campaign tab may be configured to, in response to the input location, display campaigns nearby the input location. That is, the campaign tab may filter out (or otherwise visually deprioritize) campaigns that are not nearby the input location. The displayed campaigns may be joined campaigns and/or candidate campaigns, but are preferably only candidate campaigns.

The current GPS location may be the default location, and the location search field may further be configured to enable the advocate user to search for campaigns nearby the input location, which may be other than the GPS location, by inputting keywords or other identifiers.

It will be understood that the campaign locations and input locations can be as expansive or limited as desired, so as to display the most location relevant campaigns to the advocate user. For example, some campaigns may require advocate users to be in-person present at a given address, whereas others may only require in-person presence within a given state or country, and others may only require that the advocate user is on planet earth, its moon or even mars. The displayed campaign cells would be those for which the advocate user's presence at the input location would qualify the advocate user for the corresponding campaign. Thus, for example, the input location of San Francisco, Calif., would cause the display of campaign cells for campaigns in and nearby San Francisco, Calif., as well as for those campaigns that can be completed from anywhere in California, the United States, or planet earth, for example.

In order to facilitate the further searching for campaigns, the map screen also includes an interactive map 410 with campaign pins 420 reflecting geographic locations of candidate campaigns within the adjustable boundaries of the map. The interactive map may, via the GUI, enable the advocate user to relocate and/or zoom in/out so as to redefine or adjust the map boundaries so that the advocate user can intuitively search for candidate campaigns in specific geographic locations via the displayed campaign pins.

The campaign pins may further be selectable so as to cause the GUI to display the candidate campaign tab, or a portion thereof. For example, the candidate campaign tab may only include the campaign cell corresponding to the selected candidate campaign tab. To the extent non-selected candidate campaigns are displayed, the candidate campaign tab also may be filtered (or otherwise visually deprioritized) by the map boundaries reflecting the advocate user identified location, so as to only include campaign cells of campaigns within the map boundaries. The selection of the campaign pin may cause the campaign tab to, in response to such selection, display only the campaign cell of the campaign corresponding to the selected campaign pin.

The advocate engagement system is further generally configured to enable the advocate user to use the advocate user device to join one or more campaigns. As discussed herein, the campaign tab includes one or more campaign cells, the selection of which transitions the GUI to the associated campaign screen 500 based on the current stage in the campaign selection and completion process for the corresponding campaign.

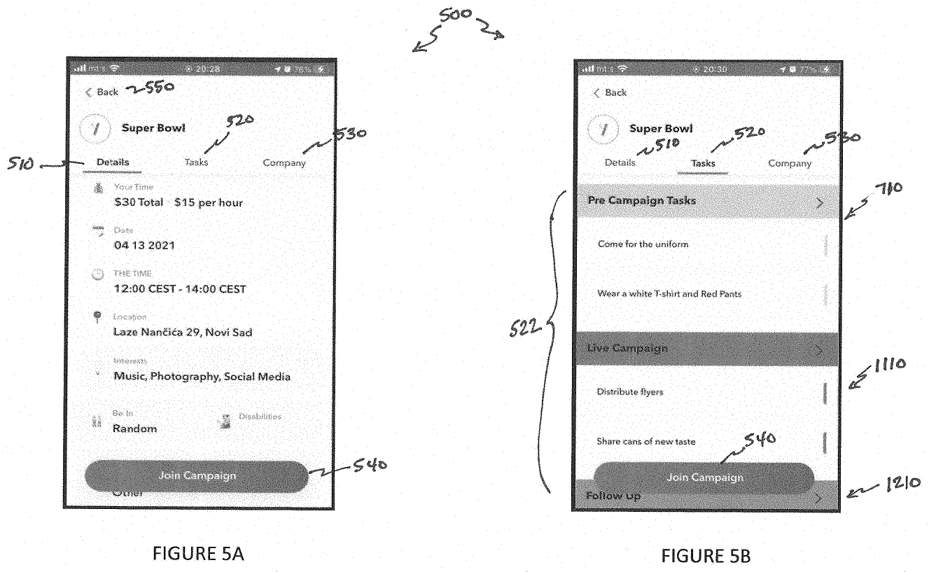

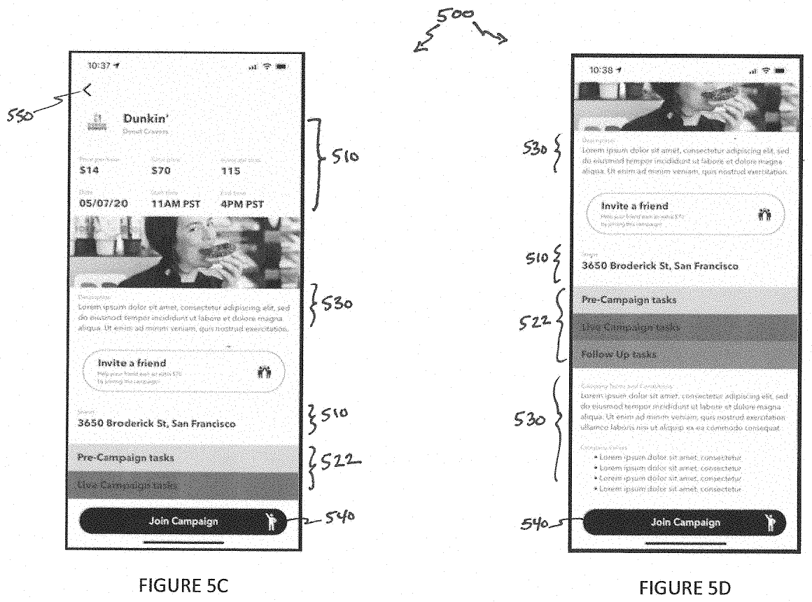

FIGS. 5A-5B show an exemplary candidate campaign screen provided by the advocate user device. FIGS. 5C-5G shows an alternative arrangement of the candidate campaign screen. FIG. 23 illustrates a still further alternative arrangement of the candidate campaign screen for an on-demand campaign. The candidate campaign screen may be transitioned to upon the selection of campaign cells of candidate campaigns during the joining period, and enables the advocate user to join the corresponding candidate campaign. The candidate campaign screen displays the campaign data for the candidate campaign, which may include the portion of the campaign data displayed in the corresponding campaign cell, and may also include additional campaign data.

The campaign data also may be organized according to sections. The sections are preferably arranged as selectable tabs and/or as sections that can be navigated to via the candidate campaign screen such that one or more sections, or portions thereof, are visible to and interactable with the user. Such navigation may be, for example via swiping or other known touch-interface gesture. The selections may be arranged in any manner that allows for the advocate user to readily view the campaign data.

The details section 510 displays the campaign data corresponding to logistic details of the candidate campaign, including but not limited to: the campaign title, compensation, date, time, duration and location. The details section may further include other campaign data, such as data related to parameters based on which the candidate campaign was presented to the advocate user, including but not limited to: interests, demographics and disabilities.

The tasks section 520 displays the campaign data corresponding to campaign tasks 522 for the selected candidate campaign. The campaign tasks may include pre-campaign tasks 710, live campaign tasks 1110, and/or follow-up campaign tasks 1210, each of which are campaign parameters defined by the requesting user, as discussed herein. The campaign tasks 522 may be organized according to nested tabs, or in any other arrangement facilitating advocate user review.

The company section 530 displays campaign data corresponding to the requesting user defining the candidate campaign. Such information may, for example, be a company profile identifying the requesting user, its values, and/or the purpose and intent of the campaign.

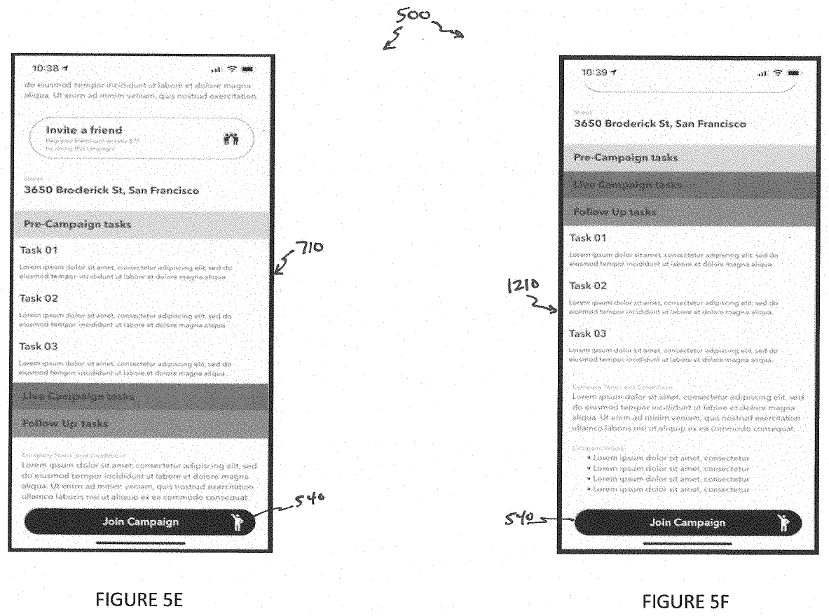

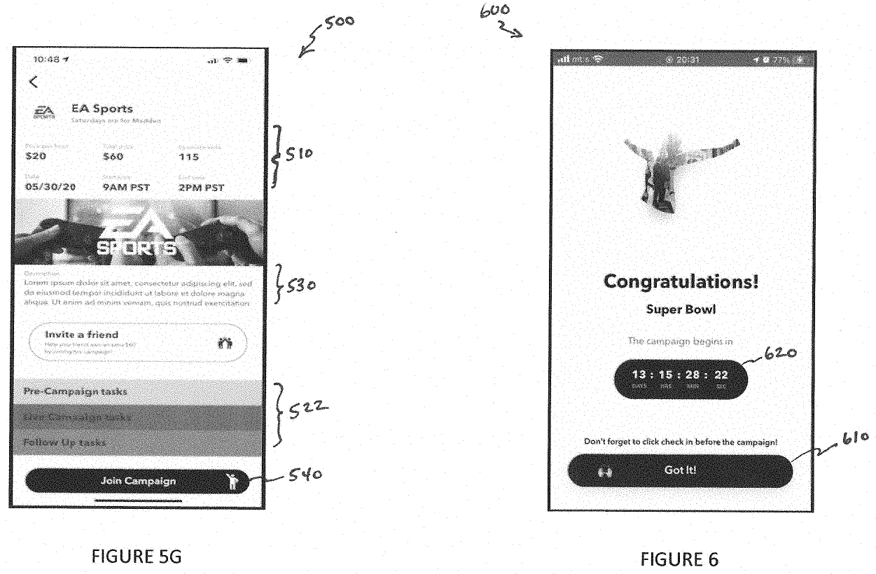

The candidate campaign screen also includes a join-campaign button 540, the selection of which by the advocate user joins the candidate campaign and transitions the GUI to a confirmation screen 600 (FIGS. 6 and 24) confirming that the advocate user has successfully joined the candidate campaign.

The user profile of the advocate user may be accordingly updated to reflect that the advocate user has joined the campaign. Additionally, or alternatively, the campaign data for the joined campaign may be updated to reflect that the advocate user has joined the campaign. The updates can occur at the advocate user device and/or the system server.

As shown in FIG. 6, the confirmation screen confirms that the advocate user has successfully joined the campaign, and functions to transition the GUI, via advocate user selection of a confirmation button 610, to the home screen. In some embodiments, the confirmation button transitions the GUI to a pre-campaign screen 700, in the event one or more pre-campaign tasks associated with the joined campaign are available for completion, and/or the campaign is otherwise available for check-in by the advocate user. The confirmation screen may further include campaign data and/or information based on campaign data, such as, for example, a countdown timer 620 reflecting the time until the campaign is to start. As shown in FIG. 24, in the case of an on-demand campaign, the timer may not be present.

Returning to FIGS. 5A-5G, the candidate campaign screen may also include a back button 550, whose selection transitions the GUI to the home screen, the map screen, or another screen from which the GUI transitioned to the candidate campaign screen, as the case may be.

The advocate engagement system is further generally configured to enable the advocate user to use the advocate user device to complete joined campaigns. The completion of campaigns may include completing one or more assigned in-person and/or on-line tasks, which behavior may be tracked, monitored and/or verified via the advocate engagement system through user use of the advocate user device, such as for example, via user social media posts and other uses of the device. As discussed herein, the campaign tab includes one or more campaign cells, the selection of which transitions the GUI to the associated campaign screen based on the current stage in the campaign selection and completion process for the corresponding campaign.

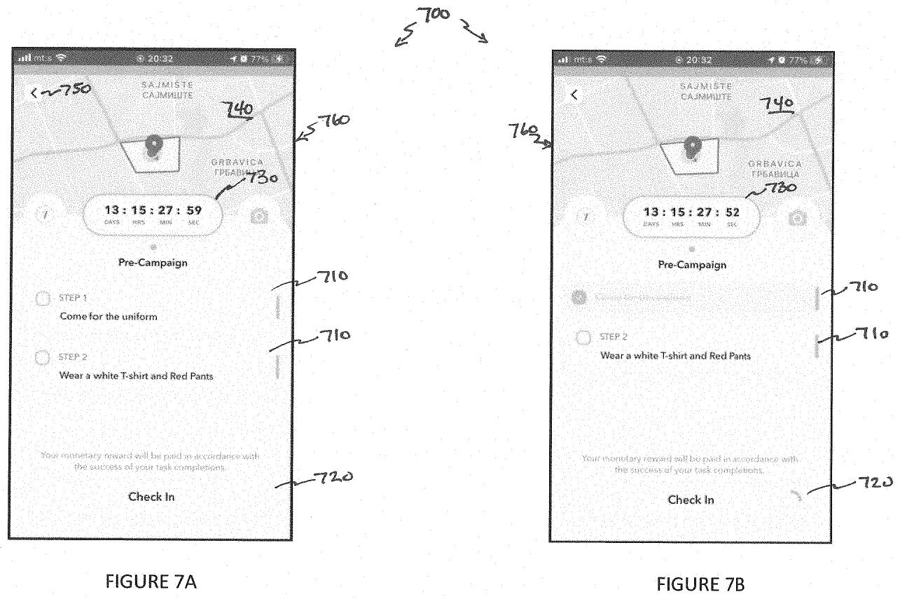

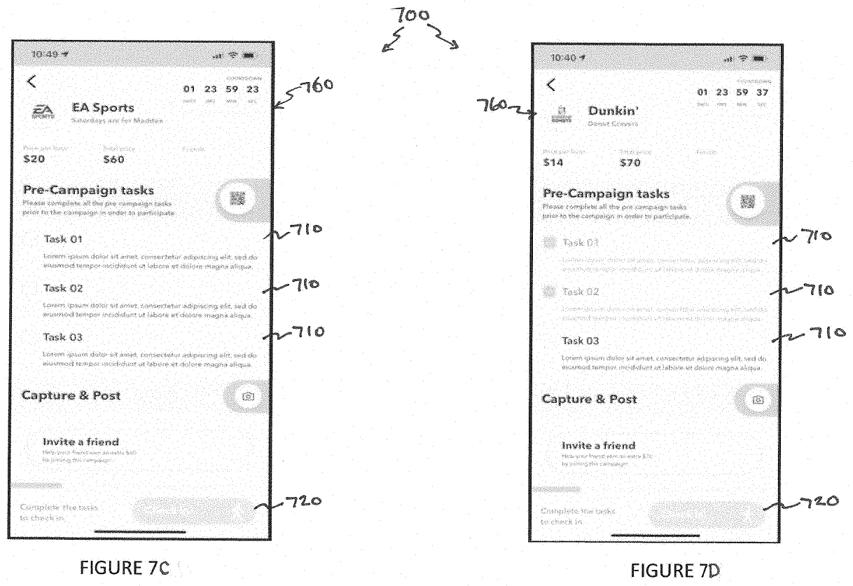

FIGS. 7A-7B show an exemplary pre-campaign screen 700 provided by the advocate user device. FIGS. 7C-7D and 26 show alternative arrangements of the pre-campaign screen. The pre-campaign screen may be transitioned to upon the selection of campaign cells of joined campaigns in the pre-campaign period, or as otherwise described, and enables the advocate user to view and verify the completion of pre-campaign tasks 710 of the corresponding campaign, as well as to check-in to the joined campaign.

The pre-campaign tasks can be any task defined by the requesting user to be completed during the pre-campaign period. For example, the pre-campaign tasks may require that the advocate user retrieve a uniform or a sample product in advance of the campaign. In some embodiments, the pre-campaign tasks are able to be verified as completed by the advocate user. This may involve, for example, checking off or otherwise indicating via the GUI that the displayed pre-campaign tasks have been completed, as shown in FIGS. 7A-7B and 7C-7D, for example. The user profile and/or campaign data may be accordingly updated to reflect the verification of one or more of the pre-campaign tasks as completed.

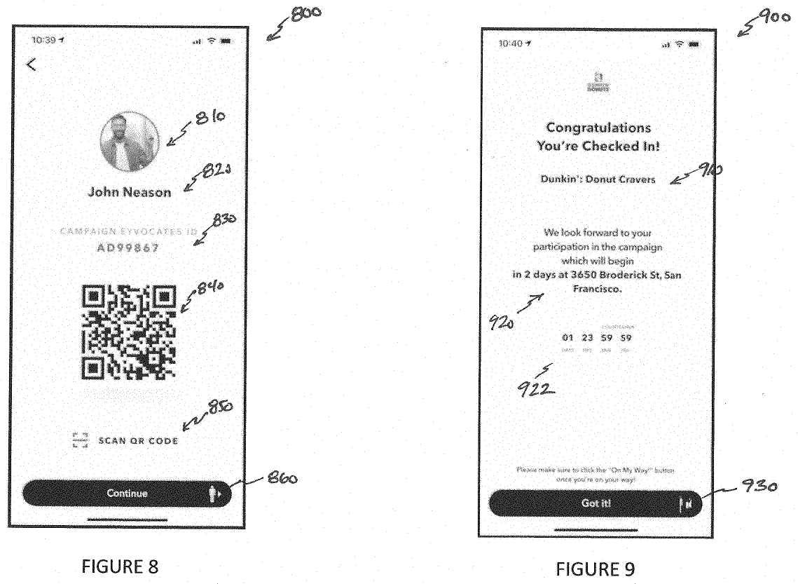

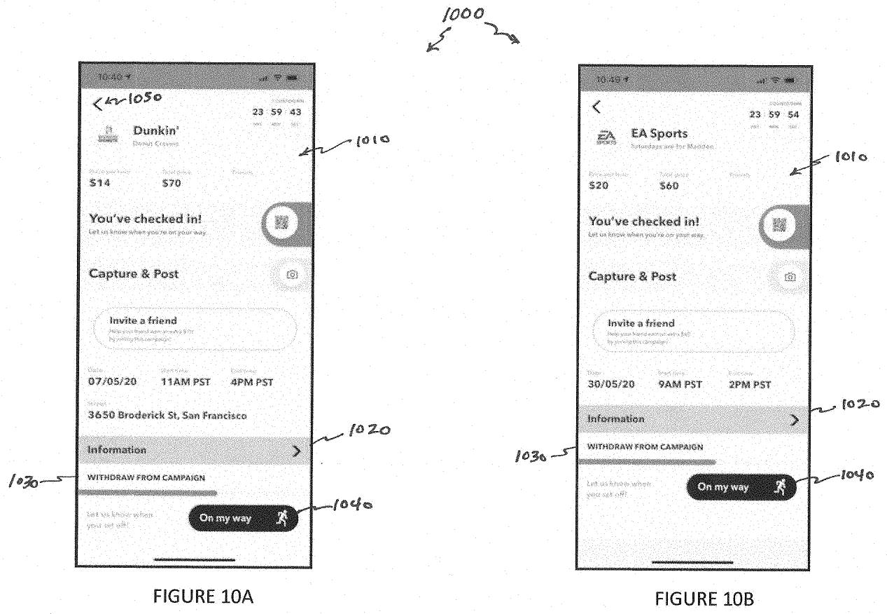

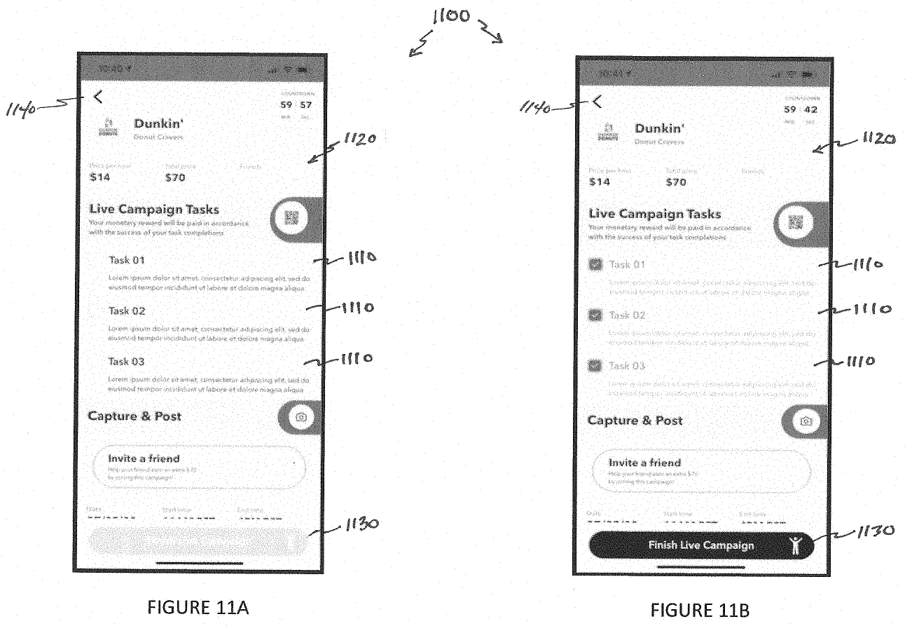

The pre-campaign screen also includes a check-in button 720, the selection of which by the advocate user checks the advocate user into the campaign. In some embodiments, the check-in button transitions the GUI to a check-in screen 800 (FIG. 8) from which the advocate user can be checked into the campaign. Checking into the campaign may transition the GUI to a check-in confirmation screen 900 (FIG. 9). Alternatively, checking into the campaign may transition the GUI to a post-check-in campaign screen 1000 (FIGS. 10A-10B), or directly to the live campaign screen 1100 (FIGS. 11A-11B).

FIG. 8 shows an exemplary check-in screen 800 provided by the advocate user device. The check-in screen may be generally configured to enable the advocate user to be checked into the campaign. The check-in screen may accordingly display user profile data that can be utilized to visually check the advocate user into the campaign in-person. The displayed user profile data can include, but is not limited to, a photo identification 810, the advocate user name 820 or advocate identification number 830. In some embodiments, the check-in screen 800 may be the confirmation screen 600, particularly for an on-demand campaign.

The check-in screen also may display a machine readable code 840, such as a QR code, that can be scanned by a corresponding code reader at the campaign location (or some other check-in location), so as to thereby check the advocate user into the campaign. The check-in screen still further may enable the advocate user device to activate other components that may be actively used for checking into the campaign. For example, the check-in screen may include a QR scan button 850, whose selection activates a QR scanning function of the advocate user device, via its AV capture module, such that the advocate user can actively scan a QR code at the campaign location (or some other check-in location) and thereby check into the campaign. As another example, a GPS button (not shown) on the check-in screen can activate a GPS function of the advocate user device, via its GPS module, such that the position of the advocate user device can be verified as currently at the campaign location (or some other check-in location), or within some predetermined geofence thereof, and the advocate user can thereby be checked into the campaign.

Returning now to FIGS. 7A-7D, in some embodiments, the check-in button may be non-selectable until the verified competition of all or some of the pre-campaign tasks. Accordingly, the advocate user is guided to ensure the completion of the pre-campaign tasks before advancing to live-campaign tasks.

Moreover, upon advocate user check-in, the user profile of the advocate user may be accordingly updated to reflect that the advocate user has checked into the campaign. Additionally, or alternatively, the campaign data for the campaign may be updated to reflect that the advocate user has checked into the campaign. The updates can occur at the advocate user device and/or the system server.

The pre-campaign screen may also display campaign data 760 for the campaign, which may include the portion of the campaign data displayed in the corresponding campaign cell, and may also include additional campaign data and/or information based on campaign data, such as, for example, the countdown timer 730, a map 740 of the location of the campaign, and any other information relevant to the advocate users' competition of the campaign.

The pre-campaign screen may also include the back button 750, whose selection transitions the GUI to the home screen, the map screen, or another screen from which the GUI transitioned to the pre-campaign screen, as the case may be.

As discussed, checking into the campaign transitions the GUI to the check-in confirmation screen 900 (FIG. 9), to the post-check-in campaign screen 1000 (FIGS. 10A-10B), or to the live campaign screen 1100 (FIGS. 11A-11B). The transition may occur automatically, or may occur upon selection of a continue button 860 from the check-in screen, or upon any action resulting in the check-in of the advocate user to the campaign.

FIG. 9 shows an exemplary check-in confirmation screen 900 provided by the advocate user device. The check-in confirmation screen confirms to the advocate user the successful check-in for the campaign. The check-in confirmation screen also may display campaign data 910 and/or information based on campaign data 920, such as, for example, the campaign name, location, and the countdown timer 922. The selection of a got-it button 930 may transition the GUI to the post check-in campaign screen 1000 (FIGS. 10A-10B), or to the live campaign screen 1100 (FIG. 11A-11B).

FIGS. 10A-10B show exemplary post-check-in campaign screens 1000 provided by the advocate user device. The post check-in campaign screen may be transitioned to upon the selection of campaign cells of campaigns that the advocate user is checked into, and enables the advocate user to view campaign data in advance of the live campaign. The post check-in screen accordingly may display campaign data 1010 and/or information based on campaign data, such as, for example, the campaign name, location. Additional campaign information may be provided via selection of one or more additional information tabs 1020.

The post check-in campaign screen may further be configured to enable the advocate user to withdraw from the campaign. The withdrawal may be via selection of a withdraw button 1030 on the post check-in campaign screen. The user profile of the advocate user may be accordingly updated to reflect that the advocate user has withdrawn the campaign. Additionally, or alternatively, the campaign data for the campaign may be updated to reflect that the advocate user has withdrawn from the campaign. The updates can occur at the advocate user device and/or the system server.

The post check-in screen may further be configured to enable to advocate user to further confirm participation in the campaign. For example, the post check-in screen may include an en route button 1040, the selection of which confirms that the advocate user is on their way to the campaign location to participate in the campaign. Again, the user profile of the advocate user may be accordingly updated to reflect that the advocate user is en route to the campaign. Additionally, or alternatively, the campaign data for the campaign may be similarly updated. The updates can occur at the advocate user device and/or the system server. The selection of the en route button may transition the GUI to the home page or the live campaign screen.

The post check-in campaign screen may also include the back button 1050, whose selection transitions the GUI to the home screen, the map screen, or another screen from which the GUI transitioned to the post check-in campaign screen, as the case may be.

FIGS. 11A-11B and 27 show alternative exemplary live-campaign screens 1100 provided by the advocate user device. The live-campaign screen may be transitioned to upon the selection of campaign cells of campaigns in the live-campaign period, or as otherwise described, and enables the advocate user to view and verify the completion of live-campaign tasks 1110 of the corresponding campaign.

The live-campaign tasks can be any task defined by the requesting user to be completed during the live-campaign period. For example, the live-campaign tasks may require that the advocate user test a product, participate in a live event (e.g., a movie screening, a pop-up concert, etc.), post on social media, etc. In some embodiments, the live-campaign tasks are able to be verified as completed by the advocate user. This may involve, for example, checking off or otherwise indicating via the GUI that the displayed live-campaign tasks have been completed. The user profile and/or campaign data may be accordingly updated to reflect the verification of one or more of the live-campaign tasks as completed.

As discussed herein, the campaign tasks may include posting, commenting, or executing some other activity on social media through the linked accounts. FIGS. 18A-18B illustrate an exemplary social media interface 1800 provided by the advocate user device, which is configured to enable the advocate user to post, comment or otherwise execute some other activity on social media through linked accounts.

For example, the advocate user device is configured to, via social media interface, transition to a content capture mode 1810 in which audio and/or visual content can be captured by the advocate user device via the AV capture module. The social media interface may further enable the advocate user to add a comment or description via a comment text field 1822 in a content editing and posting mode 1820. Other content manipulation functions can also be provided, including image editing, etc. The social media interface may still further enable the advocate user to select one or more of the linked social media accounts through which to post the captured content. The selection of the social media accounts may be via selection of one or more representative icons 1824. A share button 1830 may further be provided, the selection of which causes the advocate user device to post the captured content to the selected social media accounts.

In some embodiments, a media gallery interface 2910 may be provided such that the advocate user can capture and store media in accordance with the functions described herein. The media gallery interface may, for example, include one or more thumbnails of captured media 2912 that are selectable for uploading to the social media platform. The selection of the media content for uploading may transition the GUI to a pre-loading interface 3010 (FIG. 30) via which the user may select the representative icons 1824 of the social media platforms where the media content is to be uploaded. The pre-loading interface may further include any of the features of the posting mode 1820, and vice versa. The media gallery interface may also include a media capture button 2014 that transitions the GUI to the content capture mode discussed with reference to FIG. 18A.

Returning to FIGS. 11A-11B, the live-campaign screen may also display campaign data 1120 for the campaign, which may include the portion of the campaign data displayed in the corresponding campaign cell, and may also include additional campaign data and/or information based on campaign data, such as any information relevant to the advocate users' competition of the campaign.

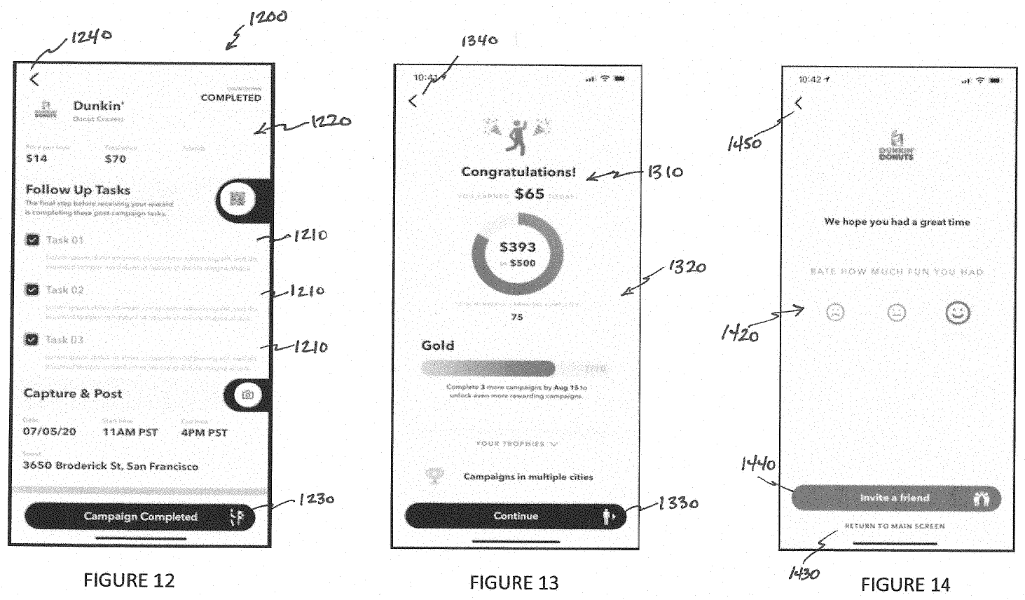

The live-campaign screen may also include a finished button 1130, the selection of which by the advocate user indicates that the advocate user has completed all of the live-campaign tasks. In some embodiments, the finished button transitions the GUI to the follow-up campaign screen 1200 (FIG. 12).

The live-campaign screen may also include the back button 1140, whose selection transitions the GUI to the home screen, the map screen, or another screen from which the GUI transitioned to the live-campaign screen, as the case may be.

FIG. 12 shows an exemplary follow-up campaign screen 1200 provided by the advocate user device. The follow-up campaign screen may be transitioned to upon the selection of campaign cells of campaigns in the follow-up campaign period, or as otherwise described, and enables the advocate user to view and verify the completion of follow-up campaign tasks 1210 of the corresponding campaign.

The follow-up campaign tasks can be any task defined by the requesting user to be completed during the follow-up campaign period. For example, the follow-up campaign tasks may require that the advocate user fill out a product review survey, post on social media, return a product, etc. In some embodiments, the follow-up campaign tasks are able to be verified as completed by the advocate user. This may involve, for example, checking off or otherwise indicating via the GUI that the displayed follow-up campaign tasks have been completed. The user profile and/or campaign data may be accordingly updated to reflect the verification of one or more of the follow-up campaign tasks as completed.

The follow-up campaign screen may also display campaign data 1220 for the campaign, which may include the portion of the campaign data displayed in the corresponding campaign cell, and may also include additional campaign data and/or information based on campaign data.

The follow-up campaign screen may also include a completed button 1230, the selection of which by the advocate user indicates that the advocate user has completed all of the follow-up campaign tasks. In some embodiments, the completed button transitions the GUI to a rewards screen 1300, to the home screen, to a review screen 1400, or to any other screen indicating to the advocate user the successful completion of the campaign. Upon the successful completion of the campaign by the advocate user, the user profile is updated to reflect that the campaign was successfully completed, and the compensation is transferred to the advocate user.

The follow-up campaign screen may also include the back button 1240, whose selection transitions the GUI to the home screen, the map screen, or another screen from which the GUI transitioned to the follow-up campaign screen, as the case may be.

FIG. 13 shows an exemplary campaign rewards screen 1300 provided by the advocate user device. The campaign rewards screen confirms to the advocate user the successful completion of the campaign. The campaign rewards screen also may display campaign data and/or information based on campaign data and/or user profile data.

For example, the campaign rewards screen may display the campaign compensation 1310, in terms of monetary compensation, points and achievements earned, etc. The campaign rewards screen also may display progress towards goals 1320 that have been input into the user profile, either automatically by the system or directly by the advocate user. Such goals may be, for example, a target amount of money earned through campaign competition, a target number of campaigns completed, a target number of different locations where a campaign has been completed, etc. The achievement of such goals may qualify the advocate user for additional rewards, such as trophies and the unlocking of additional campaigns whose parameters limit the campaigns to advocate users who have reached those goals.

The campaign rewards screen may also include a continue button 1330, the selection of which by the advocate user transitions the GUI to a review screen 1400 or to the home screen. The rewards screen may also include the back button 1340, whose selection transitions the GUI to the home screen, or another screen from which the GUI transitioned to the review screen, as the case may be.

FIG. 14 shows an exemplary campaign review screen 1400 provided by the advocate user device. The campaign review screen enables the advocate user to provide a review of the completed campaign. The campaign review screen accordingly may display one or more selectable ratings options 1420 and/or text input fields such that the advocate user may review the completed campaign. The user profile and/or campaign data may be accordingly updated to reflect the review.

The campaign review screen may also include a return button 1430, the selection of which by the advocate user transitions the GUI to the home screen. The campaign review screen may also include the back button 1450, whose selection transitions the GUI to the home screen, or another screen from which the GUI transitioned to the campaign rewards screen, as the case may be.

As shown in the figures, one or more of the campaign screens may include an invitation button 1440, via which the advocate user can send an invitation message to a friend (i.e., a contact imported from a contacts list or directly added to the user profile) to join the candidate campaign.

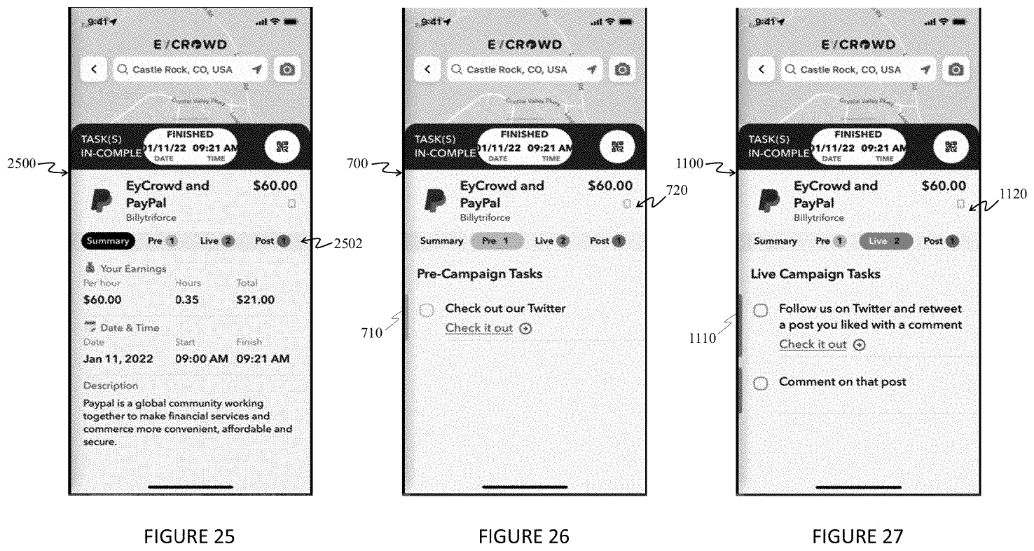

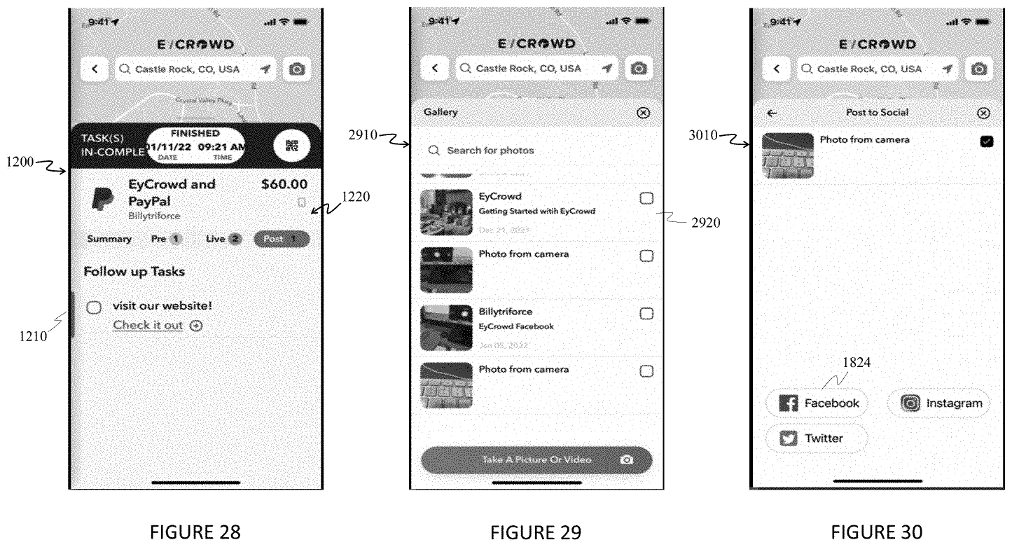

In some embodiments, the selection of the campaign cell may transition the GUI to an active campaign screen 2500 from which the pre-campaign screen, the live-campaign screen and/or the post-campaign screen can be accessed. For example, FIG. 25 shows an exemplary active campaign screen 2500 via which the pre-campaign screen (FIG. 26), the live-campaign screen (FIG. 27) and/or the post-campaign screen (FIG. 28) can be accessed by swiping or by touching corresponding tabs 2502. The active campaign screen 2500 may also be returned to by swiping or by touching the corresponding tabs 2502. The pre-campaign screen (FIG. 26), the live-campaign screen (FIG. 27) and/or the post-campaign screen (FIG. 28) may include some or all of the features described with reference to FIGS. 7A-7D, 11A-11B and 12. Moreover, it will be understood that, while not expressly shown, any of the other screens may be accessed via the active campaign screen 2500.

Turning now to FIG. 15, the advocate user device is configured to provide a menu screen 1500, which may include one or more selectable menu options for the advocate user. Each menu option may comprise a navigable link to another screen, including but not limited to: a home screen link 1510, a profile screen link 1520, a notifications screen link 1530, a my-campaigns screen link 1540, a social media screen link 1550, a why-not screen link 1560, a wallet screen link 1570, and a help screen link 1580. The menu screen may also include a log-out button 1590 that logs the advocate user out of the system.

The home screen link 1510 transitions the GUI to the home screen, whereas the help screen link 1580 transitions the GUI to a help screen that may comprise an interactive helpdesk or may display information for contacting customer service, and the wallet screen link 1570 transitions the GUI to a wallet screen configured to enable the advocate user to link financial account information to the user profile so that compensation may be transferred to the advocate user upon the successful completion of each campaign.

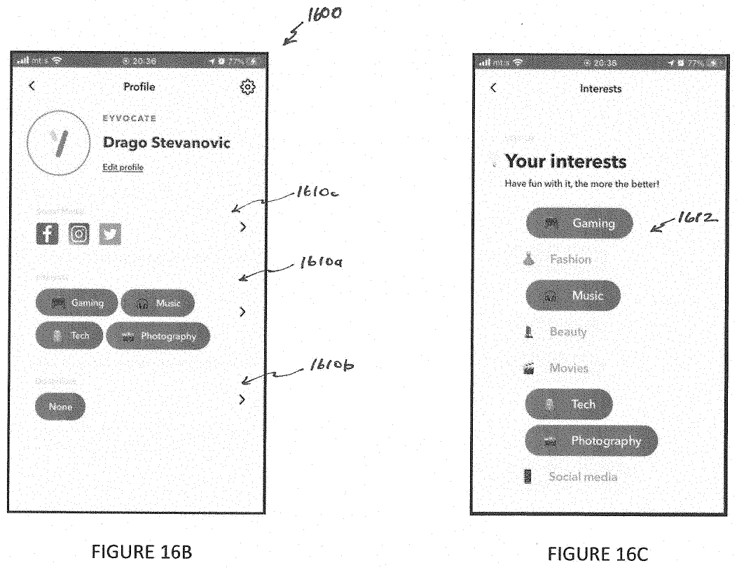

The profile screen link 1520 transitions the GUI to a user profile screen 1600 via which the advocate user can generate, update and otherwise maintain its user profile. An exemplary user profile screen is shown in FIG. 16A. The user profile screen may include one or more fields 1610 into which the advocate user can input, edit and delete user profile data, via one or more of text input, drop-down selection, or any other method of data input. An alternative arrangement for the user profile screen is shown in FIGS. 16B-16C, which illustrates the inputting of user profile data via the selection of interest icons 1612.

As discussed herein, the user profile data may include user interests and demographics, which can be utilized by the system server to identify candidate campaigns for presentation to the advocate user. Accordingly, the user profile screen preferably includes a user interest field 1610a and a demographics field 1610b (e.g., disabilities).

The user profile screen also preferably includes a social media field 1610c, which identifies social media accounts that are linked to the user profile of the advocate user, and allows for the linking and unlinking of such social media accounts. In some embodiments, the social media field comprises a link, the selection of which transitions the GUI to the social media screen 1700.

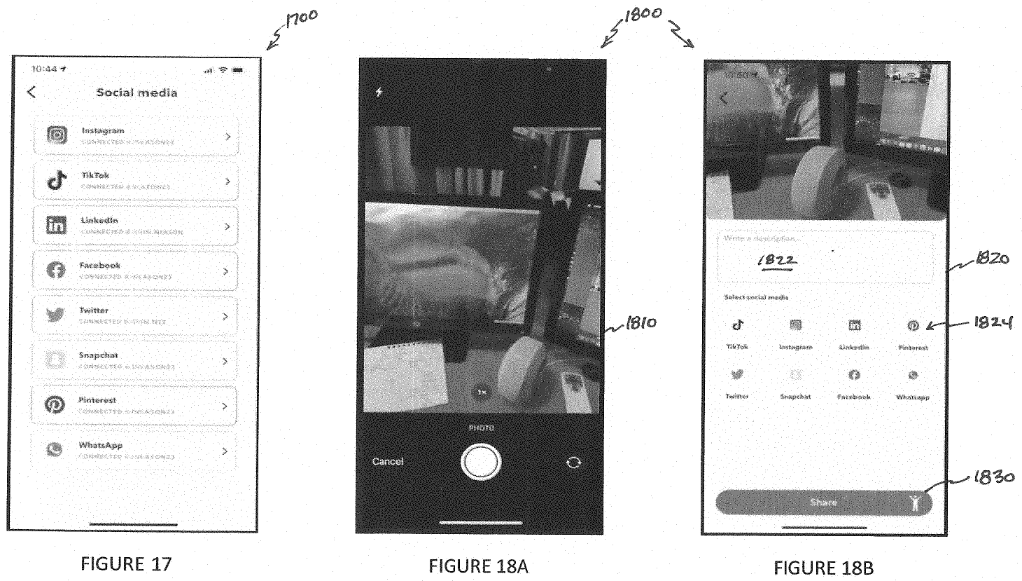

The social media screen link transitions the GUI to the social media screen 1700 via which the advocate user can generate, update and otherwise maintain the social media accounts linked to the user profile. FIG. 17 shows an exemplary social media screen, which is generally configured to enable the advocate user to link and unlink various social media accounts to the user profile. As discussed herein, the campaign tasks may include posting, commenting, or executing some other activity on social media through the linked accounts.

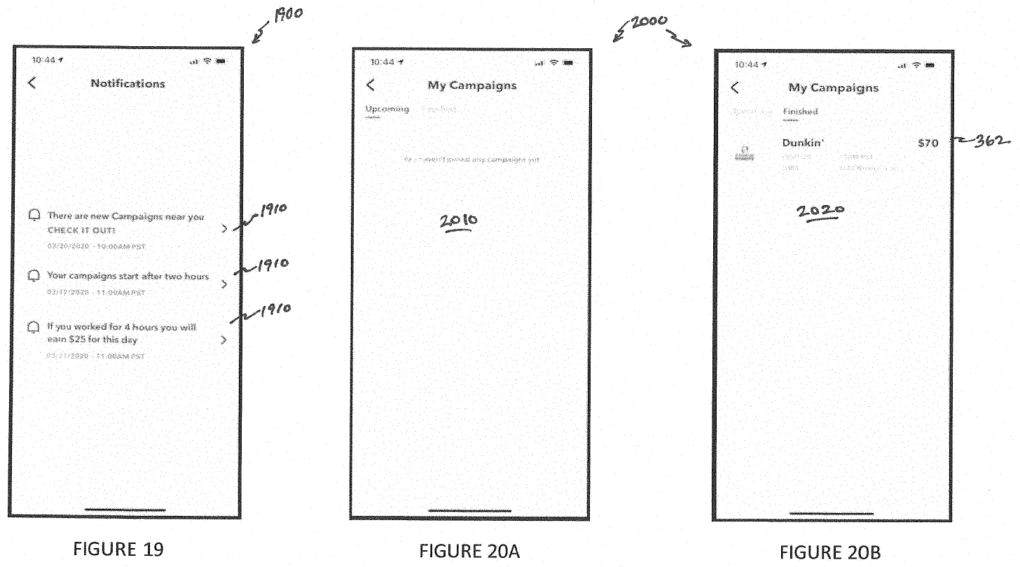

The notifications screen link transitions the GUI to a notifications screen 1900 via which the system can provide notifications 1910 to the advocate user. FIG. 19 shows an exemplary notifications screen, which is generally configured to receive and display notifications from the system. The notifications may be related to candidate campaigns, joined campaigns, completed campaigns, goals, software updates, or any other subject appropriate for notification.

The my-campaigns screen link transitions the GUI to a my-campaigns screen 2000 via which the advocate user can review and otherwise manage joined, in-progress, upcoming, and/or completed campaigns. FIGS. 20A-20B show an exemplary my-campaigns screen. The my-campaigns screen can include the campaign cells for the joined and/or completed campaigns, the selection of which can transition the GUI to the appropriate campaign screen based on the period and/or status of the corresponding campaign. The joined and completed campaigns may be provided in a joined campaign tab 2010 and a completed campaign tab 2020, respectively.

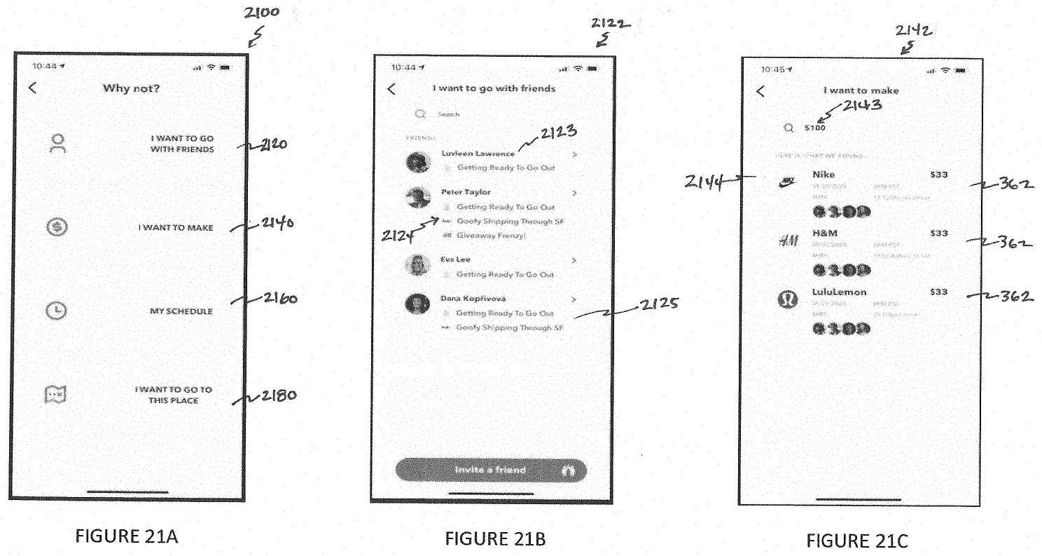

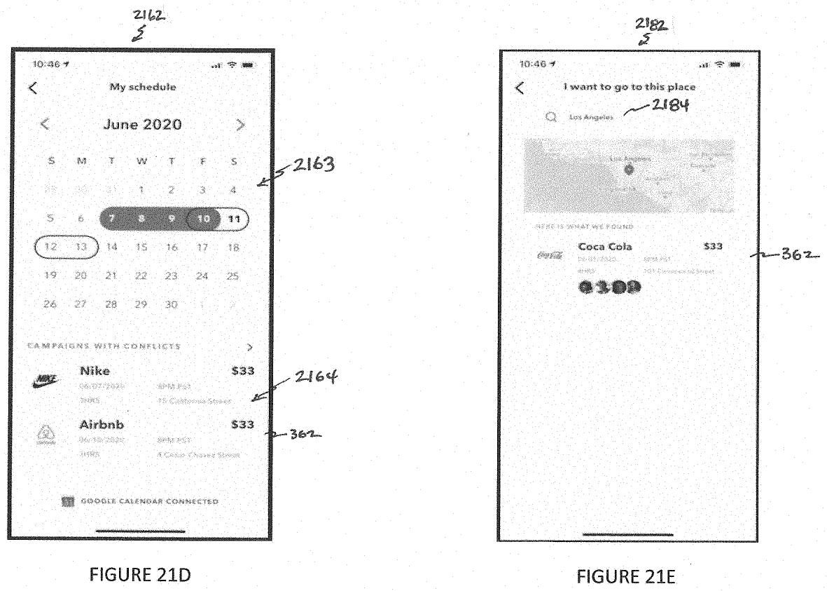

The why-not option transitions the GUI to a why-not screen 2100, via which the advocate user can explore motivations for participating in campaigns. An exemplary why-not screen is shown in FIG. 21A. The why-not screen may include tabs that link to motivation screens.

A go-with-friends tab 2120 transitions the GUI to a go-with-friends screen 2122 (FIG. 21B), via which the advocate user can see the campaign activity of one or more friends. The go-with-friends screen is accordingly configured to display the campaign activity of the one or more friends in real-time. In at least some embodiments, the advocate user name 2123 of each friend is displayed in connection with one or more campaigns 2124 that the friend has joined. A status identifier 2125 may also be displayed, indicating where the friend is in the campaign completion process.

A make-money tab 2140 transitions the GUI to a make-money screen 2142 (FIG. 21C), via which the advocate user can set, update and otherwise track progress towards a monetary earnings goal 2143. In some embodiments, upon setting the monetary earnings goal, candidate campaigns whose compensations add up to the monetary earnings goal can be determined by the system and displayed in a modified campaign tab 2144.

A my-schedule tab 2160 transitions the GUI to a my-schedule screen 2162 (FIG. 21D), via which the advocate user can view a schedule of joined and/or candidate campaigns generated based on the campaign data and/or user profile data. In some embodiments, the schedule takes the form of a calendar 2163 and/or a list 2164. In some embodiments, the schedule can be linked to one or more calendars accessible by the software application, and the my-schedule screen can be configured to display candidate campaigns (e.g., via a modified campaign tab) during dates, times and locations that the advocate user is otherwise unoccupied based on the calendar.

A travel tab 2180 transitions the GUI to the travel-screen 2182 (FIG. 21E), via which the advocate user can view candidate campaigns (e.g., via a modified campaign tab) for potential destinations. The travel screen can function in one or more respects substantially similar to the maps screen, in order to provide the candidate campaigns in response to the input destination 2184.

Other selectable menu options and/or links may be provided on the menu screen, including, for example, a link to a my-friends screen configured to enable the advocate user to import contacts lists or otherwise add and delete contacts as friends within the system, and otherwise manage such contacts and contact information.

The embodiments described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements. In particular, for example, the functionalities of two or more various block chains discussed herein may be combined into a single block chain, or vice versa.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

What is claimed is:

1. A system, comprising:
a database having one or more campaigns stored thereon, wherein each campaign is associated with one or more tasks for completion and a requesting user;
an advocate user device communicatively coupled to the database, the advocate user device having an interactive device-based platform configured to enable an advocate user, via the advocate user device, to:
join a campaign from among the one or more campaigns stored on the database,
complete tasks associated with the joined campaign, and
verify the completion of tasks associated with the selected campaign to the requesting user.

2. The system of claim 1, wherein the interactive device-based platform is further configured to display campaign data, including respective locations, dates, times and durations, associated with the one or more campaigns.

3. The system of claim 1, wherein the tasks include: (a) one or more pre-campaign tasks completable prior to the campaign, (b) one or more live-campaign tasks completable during the campaign, and (c) one or more post-campaign tasks completable after the campaign.

4. The system of claim 3, wherein the pre-campaign tasks include: checking-in to the campaign, and obtaining merchandise or other articles.

5. The system of claim 3, wherein the live-campaign tasks include: testing merchandise, participating in a live event, and posting on social media.

6. The system of claim 3, wherein the post-campaign tasks include: completing a product review or survey, posting on social media, returning merchandise or other articles.

7. The system of claim 1, wherein verifying the completion of the tasks includes checking-off graphical representations of the tasks displayed via the interactive device-based platform.

8. The system of claim 1, wherein the interactive device-based platform is further configured to cause the advocate user device to:
capture media related to the joined campaign,
store the captured media in a media gallery of the interactive device-based platform, and
upload the stored media to a social media platform operating on the advocate user device.

9. A method, comprising:
storing one or more campaigns on a database, wherein each campaign is associated with one or more tasks for completion and a requesting user;
configuring an advocate user device with an interactive device-based platform, wherein the interactive device-based platform communicatively couples the advocate user device to the database, and enables an advocate user, via the advocate user device, to:
join a campaign from among the one or more campaigns stored on the database,
complete tasks associated with the joined campaign, and
verify the completion of tasks associated with the selected campaign to the requesting user.

10. The method of claim 9, wherein the interactive device-based platform is further configured to display campaign data, including respective locations, dates, times and durations, associated with the one or more campaigns.

11. The method of claim 9, wherein the tasks include: (a) one or more pre-campaign tasks completable prior to the campaign, (b) one or more live-campaign tasks completable during the campaign, and (c) one or more post-campaign tasks completable after the campaign.

12. The method of claim 11, wherein the pre-campaign tasks include: checking-in to the campaign, and obtaining merchandise or other articles.

13. The method of claim 11, wherein the live-campaign tasks include: testing merchandise, participating in a live event, and posting on social media.

14. The method of claim 11, wherein the post-campaign tasks include: completing a product review or survey, posting on social media, returning merchandise or other articles.

15. The method of claim 9, wherein verifying the completion of the tasks includes checking-off graphical representations of the tasks displayed via the interactive device-based platform.

16. The method of claim 9, wherein the interactive device-based platform is further configured to cause the advocate user device to:
capture media related to the joined campaign,
store the captured media in a media gallery of the interactive device-based platform, and upload the stored media to a social media platform operating on the advocate user device.

17. An advocate user device comprising:
a touch-display; and
a processor configured to execute an interactive device-based platform thereon, so as to generate an interactive graphical user interface on the touch-display, wherein the interactive graphical user interface enables an advocate user, via the advocate user device, to:
join a campaign from among the one or more campaigns stored on the database,
complete tasks associated with the joined campaign, and
verify the completion of tasks associated with the selected campaign to the requesting user.

18. The advocate user device of claim 17, further comprising:
a media capturing unit; and
a social network platform executed by the processor,
wherein the interactive device-based platform is further configured to:
cause the media capturing unit to capture media related to the joined campaign,
store the captured media in a gallery of the interactive device-based platform, and
upload the stored media to the social media platform.
